(19) United States
(12) Patent Application Publication
(10) Pub. No.: US 2021/0374830 A1
(43) Pub. Date: Dec. 2, 2021

(54) ESSENTIAL ACCESSORY RECOMMENDATIONS

(71) Applicant: Home Depot Product Authority, LLC, Atlanta, GA (US)

(72) Inventor: Simon Hughes, Riverside, IL (US)

(21) Appl. No.: 17/336,121

(22) Filed: Jun. 1, 2021

Related U.S. Application Data
(60) Provisional application No. 63/032,908, filed on Jun. 1, 2020.

(51) Int. Cl. G06Q 30/06; G06N 20/00; G06F 16/9535; G06F 16/9538

(52) U.S. Cl. CPC G06Q 30/0631; G06N 20/00; G06Q 30/0625; G06F 16/9538; G06Q 30/0641; G06F 16/9535

(57) ABSTRACT

A method includes determining, by a processor of a computing device, user behavior data comprising a plurality of ordered user interactions with a plurality of items via an electronic interface. The method further includes replacing, by the processor, each of the plurality of items in the user behavior data with a respective item type of a plurality of item types and replacing, by the processor, a predetermined number of the respective item types in the plurality of ordered user interactions with a respective parent item type of a plurality of parent item types from an item taxonomy. The method further includes inputting, by the processor, the plurality of ordered user interactions into a machine learning algorithm to train the machine learning algorithm to determine an anchor/accessory relationship between at least one of the plurality of item types and at least one of the plurality of parent item types.

### CROSS REFERENCE TO RELATED APPLICATION

This application claims priority to and the benefit of U.S. Provisional Appln. No. 63/032,908, filed on Jun. 1, 2020, the disclosure of which is incorporated herein by reference in its entirety.

### BACKGROUND

Both a retailer and its customers can benefit from the retailer providing content on a webpage that may be more relevant or of use to a viewer of the webpage. For example, the retailer may provide various types of recommendations on a website or other graphical user interface. Recommendations may increase the retailer's sales, and may introduce useful or necessary data or information to the customer that the customer may otherwise not have found or been aware of.

### SUMMARY

A computer-implemented method includes determining, by a processor of a computing device, user behavior data comprising a plurality of ordered user interactions with a plurality of items via an electronic interface. The method further includes replacing, by the processor, each of the plurality of items in the user behavior data with a respective item type. The method further includes constructing, by the processor, an item graph using the user behavior data. The item graph comprises a plurality of interconnected nodes indicative of a plurality of item types. The plurality of interconnected nodes are further configured to a probability for how likely two item types are to appear together in the plurality of ordered user interactions. The method further includes performing, by the processor, a plurality of random walks through the item graph to generate a plurality of node sequences. The plurality of random walks are performed based on the probability for how likely two item types are to appear together in the plurality of ordered user interactions. The method further includes replacing, by the processor, a predetermined number of nodes represented in the plurality of node sequences with a respective parent item type of a plurality of parent item types from an item taxonomy. The method further includes inputting, by the processor, the plurality of node sequences into a machine learning algorithm to train the machine learning algorithm to determine an anchor/accessory relationship between at least one of the plurality of item types and at least one of the plurality of parent item types.

A method includes determining, by a processor of a computing device, user behavior data comprising a plurality of ordered user interactions with a plurality of items via an electronic interface. The method further includes replacing, by the processor, each of the plurality of items in the user behavior data with a respective item type of a plurality of item types and replacing, by the processor, a predetermined number of the respective item types in the plurality of ordered user interactions with a respective parent item type of a plurality of parent item types from an item taxonomy. The method further includes inputting, by the processor, the plurality of ordered user interactions into a machine learning algorithm to train the machine learning algorithm to determine an anchor/accessory relationship between at least one of the plurality of item types and at least one of the plurality of parent item types.

### BRIEF DESCRIPTION OF THE DRAWINGS

FIG. 1 is a flow chart illustrating an example method of presenting a webpage with essential accessory information to a user, in embodiments.

FIG. 2 is a block diagram view of an example system for determining essential accessory recommendations, in embodiments.

FIGS. 3A and 3B illustrate an example method for determining essential accessory recommendations, in embodiments.

FIGS. 4A and 4B illustrate another example method for determining essential accessory recommendations, in embodiments.

FIG. 5 is a diagrammatic view of an example user computing environment, according to some embodiments.

### DETAILED DESCRIPTION

Viewers of a website or other graphical user interface may often look at items or other information on one or more webpages of the website. An item may be related to a particular webpage selected by a user, or the item may be searched for by a user leading to a webpage related to that item. In various embodiments, one or more items displayed on a webpage may be related to goods or products, such as appliances, fixtures, hardware, wall coverings, or any other goods. It may be useful to display, along with a primary item, information about another item or items that may be related to or used along with the primary item. In various embodiments, a primary item, also referred to herein as an anchor item, may not be used without an associated item. As nonlimiting examples, a user may not use nails without a hammer, or may not use paint without a paint brush. As such, one item type may be considered to include items that are essential accessories for another item type when use of a first item type typically includes use of a second item type. Said another way, an essential accessory may be a first item that is needed to use or install a second item (or anchor item). For example, a hammer item type may be considered an essential accessory for a nails item type, and a paint brush item type may be considered an essential accessory for a paint item type. It may be beneficial to both the user and to a retailer or other entity displaying items on a website to present essential accessories to a user automatically, for example, on a webpage of a website related to one or more items. For example, in response to a user selection of a primary item (also referred to herein as an anchor item) of a first type on a retailer or other entity website, the other items of a second item type that may be an essential accessory to the anchor item may also be displayed to the user.

In addition, although retailer websites are discussed herein, the methods and systems may be used for other websites or electronic user interfaces other than those hosted by or otherwise controlled by a retailer. For example, blogs that review products may desire to show essential accessories of an item selected by a user. In another example, websites that display item manuals or specifications for informational purposes may desire to show essential accessories of an item selected by a user. As such, use of the systems and methods described herein are not limited to use within a website operated by a retailer.

Anchor/accessory relationships have been known to be manually-created. Manual creation and maintenance of anchor/accessory relationships can be unduly burdensome to store and maintain, especially where a large number of anchor/accessory relationships for a large number of items may be stored and used. In such instances, an entity storing the relationships may have to frequently update that anchor/accessory relationship information, including removing old or irrelevant items/products, adding new items/products, creating new anchor/accessory relationships, and/or eliminating old anchor/accessory relationships as items/products are added to and/or removed from the retailer's or other entity's database. Accordingly, automated determination of anchor/accessory relationships can provide a substantial reduction of resources required by the retailer or other entity to create and maintain anchor/accessory relationships, and can further provide improved and more up-to-date accessory recommendations to users. As a result, the need for users to navigate to different portions of a website of the retailer to find essential accessory items may be reduced, the workload of the servers and systems supporting the website may therefore be reduced, and the responsiveness and functionality of those servers and systems thereby improved.

Such a database of anchor/accessory relationships for items may be a repository stored on or in memory of or associated with one or more servers that are in electronic communication with an electronic interface on which essential accessory item information may be displayed. The anchor/accessory relationships may be stored as item documents or as data fields in a database, and may for example be used to populate product or item information webpages or other graphical user interfaces that are displayable on an electronic interface to a user. Such information may be used to assemble webpages or other graphical user interfaces for display to a user irrespective of whether the items (e.g., anchor items, essential accessory items, etc.) relate to products that are available for purchase via the electronic interface or other graphical user interface provided by or provided in conjunction with the memory or the one or more servers. Accordingly, the one or more servers may provide information about items, including information about one or more essential accessories for an anchor item, directly on an electronic interface. Similarly, the one or more servers may provide information about items, including information about a plurality of essential accessories for a plurality of anchor items on one or more interfaces or webpages (e.g., on electronic interfaces such as landing pages, search result pages, item category or compilation pages, or the like).

The present disclosure includes systems and methods for providing essential accessory recommendations. The recommendations may be provided in conjunction with the viewing, selection, or purchase of a so-called “anchor product” or “anchor item” through an electronic user interface, such as one on an e-commerce website, a mobile application, a kiosk in a brick-and-mortar store, or elsewhere. Still further, recommendations may be provided on a digital display (e.g., in a brick-and-mortar building) associated with the anchor item type. The recommendations may include items, such as products, that are complementary or may otherwise be used with the anchor item. For the remainder of this disclosure, recommendations will generally be described as being provided on a website. Such disclosure is by way of example only. The same or similar functionality described herein as being provided on or through a website may also be provided through other user interfaces such as a mobile application, physical kiosk, or otherwise.

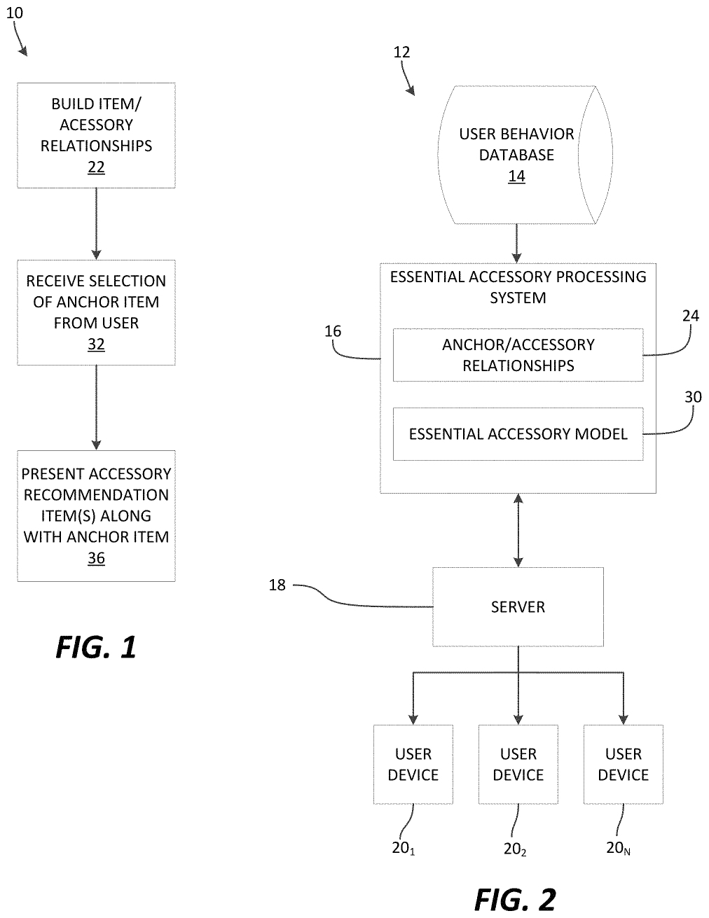

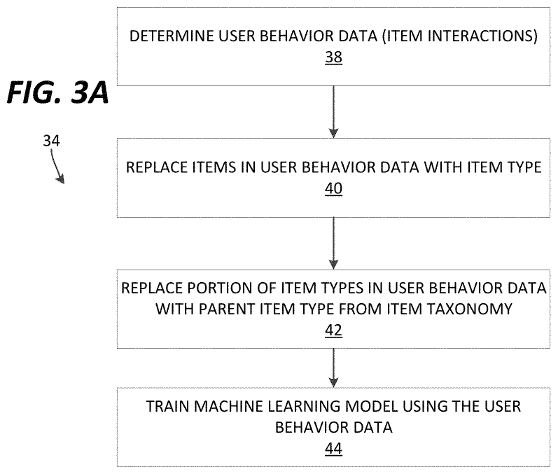

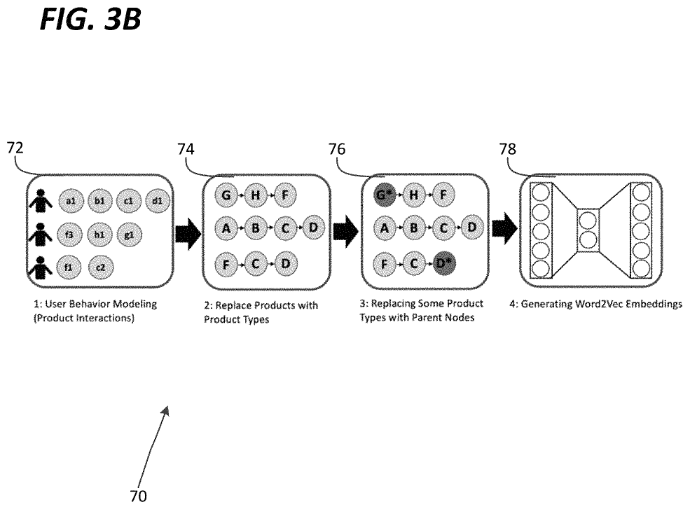

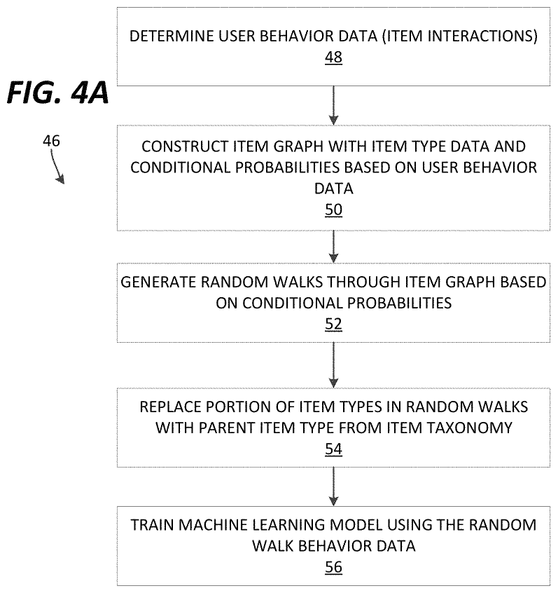

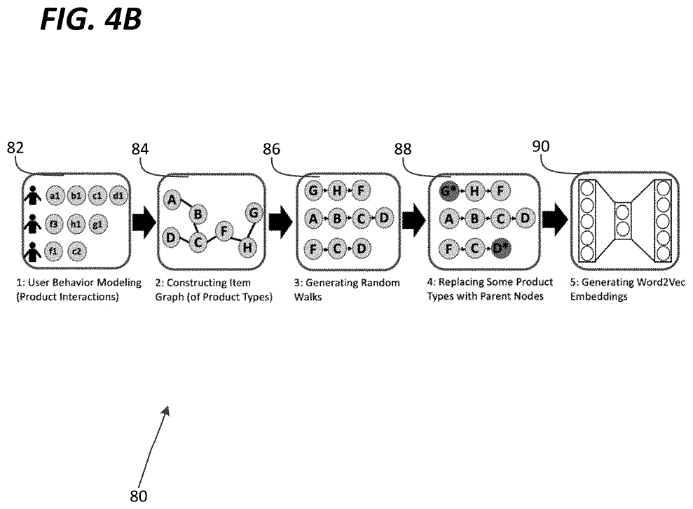

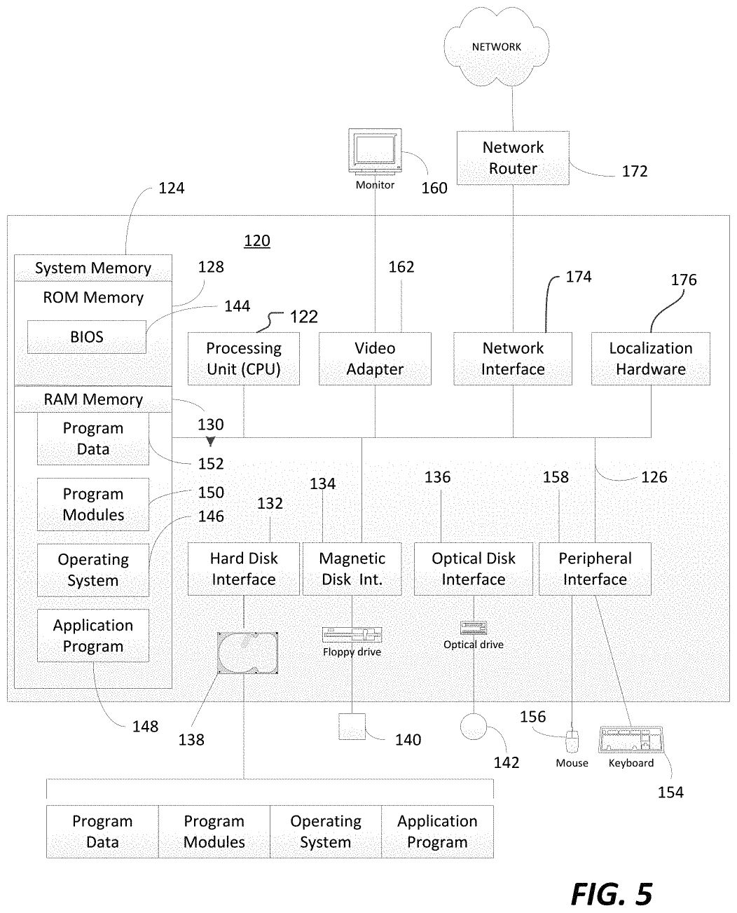

First, with respect to FIGS. 1 and 2, an illustrative method and illustrative system for automatically determining essential anchor/accessory relationships and providing essential accessory recommendations will be described at a high level. With respect to FIGS. 3A and 3B, a first illustrative method for automatically determining essential accessory recommendations will be described. With respect to FIGS. 4A and 4B, a second illustrative method for automatically determining essential accessory recommendations will be described. Finally, with respect to FIG. 5, an illustrative computing environment that may be used in conjunction with the methods and processes of this disclosure will be described.

Referring to the drawings, in which like numerals refer to the same or similar features in the various views, FIG. 1 is a flow chart of an illustrative method 10 for providing essential accessory recommendations to a customer. FIG. 2 is a block diagram of an illustrative system 12 for providing essential accessory recommendations to a user. The method 10 of FIG. 1 and the system 12 of FIG. 2 are described in conjunction below.

Generally, the method 10 may include receiving a selection of an item from a user and presenting an essential accessory recommendation based on the user-selected item. An item selected by a user, with which recommendations may be provided according to the present disclosure, may be referred to as an “anchor product” or “anchor item.” The item recommendations may include items that are essential accessory recommendations for the anchor item.

The system 12 generally includes computer hardware and functional capability for carrying out the method 10 and other methods and functions of this disclosure. The system 12 may include a user behavior database 14, an essential accessory processing system 16, and a server 18 in electronic communication with a plurality of user devices 201, 202, . . . 20N, which may be referred to individually as a user device 20 or collectively as user devices 20. The system 12 may also perform other methods of this disclosure and may provide one or more electronic user interfaces and/or graphical presentations to the user. The system 12 may also host or otherwise provide one or more websites, mobile applications, and the like, in embodiments.

The method 10 will be described in terms of a user, such as a customer, interacting with a website. The server 18 may host or provide that website, and accordingly may receive input from the user through the website. The server 18 may exchange information with the essential accessory processing system 16 to carry out one or more steps of the method 10, in embodiments. In other embodiments, the server 18 and the essential accessory processing system 16 may be the same processing system or apparatus.

The method 10 may be performed, in part or in full, by a retailer, in embodiments. That is, the system 12 may be owned or operated by or on behalf of a retailer or other entity, in embodiments. The method 10 may also be carried out, in full or in part, by some other type of entity. A website displayed on an electronic interface having the features referenced herein may be the website of a retailer or other entity, and the brick-and-mortar stores referenced herein may be stores of the same retailer. Additionally or alternatively, a website or other electronic interface having the features described herein may be associated with one or more different entities than a retailer. A website or other electronic interface having the features described herein may list and sell items sold by the retailer, in embodiments. Additionally or alternatively, such a website may list and sell items sold by third parties.

The method 10 may include a step 22 of building anchor/accessory relationships. Example embodiments of the step 22 are illustrated in and will be described (as methods) in greater detail with respect to FIGS. 3A, 3B, 4A and 4B. With continued reference to FIGS. 1 and 2, the anchor/accessory relationship building step 22 may generally include utilizing user behavior data in the user behavior database 14 to determine, based on historical user behavior (e.g., interactions with items, a website, in a store, etc.) to determine essential accessory recommendations for anchor items. The building step 22 may result in a set of anchor/accessory relationships 24 stored in memory of the essential accessory processing system 16. In an embodiment, the anchor/accessory relationships 24 may include one or more lookup tables comprising the anchor/accessory relationships, so that the system may determine a recommendation for a given anchor item from the lookup table(s).

With continued reference to FIGS. 1 and 2, the method 10 may further include a step 32 of receiving a selection of an anchor item from a user. The selection may be received, for example, by the essential accessory processing system 16 from a user device 20 through a website provided by the server 18 or through another electronic user interface such as a mobile application, physical kiosk, etc. As noted above, the website may be, for example, an e-commerce site associated with or operated by or on behalf of a retailer. The selection may be, for example only, a click on the anchor item on a page of the website, navigation to an item information page of the anchor item on the website, a user action to add the anchor item to the user's shopping cart on the website, etc.

In an embodiment, a selection of an anchor item may be received from a user through a voice search or request through the electronic user interface. For example, the electronic user interface with which the user interacts may be on a mobile application, and the mobile application may be configured to capture voice search requests from the user. The server 18 or user device 20 may be configured with voice recognition software to parse the user's voice search or voice request to determine an anchor item. In response to the voice search or voice request, the server may provide a list recommended accessory items for the anchor item to the user through the electronic user interface, as described below.

In another embodiment, a selection of an anchor item may be received from a user through a text-based (e.g., SMS or MMS) request. For example, the user may transmit a text message specifying an anchor item from a user device 20 and, in response, the server 18 may transmit a list of items recommended as an accessory for the anchor item to the user device 20.

With continued reference to FIGS. 1 and 2, the method 10 may further include a step 36 of presenting an essential accessory recommendation item(s) for purchase with the anchor item. The additional items may be presented, for example, on the website adjacent to a listing of the anchor item. In embodiments, where the anchor item is selected by the user via the user's navigation to an item information page of the anchor item, the additional items may be presented on the anchor item's information page. The additional items may be presented in conjunction with graphical control elements that enable the user to select or otherwise interact with the additional items and/or anchor item. The graphical control elements may, for example, enable the user to learn more about the items by selecting the items, and/or may allow the user to purchase the items by initiating a purchase (e.g., adding to cart) or by completing a purchase (e.g., checking out, performing a 1-click purchase, etc.), in embodiments.

The method 10 advantageously provides essential accessory item recommendations to customers on a website and allows the customers to purchase recommended items with a reduced number of clicks. Instead of separately selecting and separately navigating to an item information page of each of the recommended additional items, the method 10 provides a quicker way for the customer to purchase the anchor item and the additional items. Furthermore, the method 10 reduces the number of pages to which a user must navigate, thereby reducing server workload and improving server functionality.

The presenting step 36 may include presenting a graphical display of multiple items that are essential accessory recommendations for the user-selected anchor item without additional website navigation by the user. For example, the additional items may be displayed on or over an item information page so that, from the item information page of the anchor item, the user can add the anchor item and one or more of the recommended additional items to the user's cart. In addition to, or instead of, providing the item recommendations on the item information page of the anchor item, item recommendations may be provided in a web page showing the user's cart, on an item search page, or otherwise.

The “user” noted in the method may be a customer that is shopping on a website provided by the server with a user device 20, in embodiments. The user device 20 may be a personal computer, user mobile computing device, or other computing device. Additionally or alternatively, the server 18 may provide all or part of an in-store checkout or informational environment or digital display information, and the user devices 20 may be physical kiosks or digital displays.

FIG. 3A is a flow chart illustrating an embodiment of a method 34 for building anchor/accessory relationships according to various embodiments as described herein. A graphical representation of the method 34 is shown in method 70 of FIG. 3B. The method 34 may find use as the first step 22 in the method 10 of FIG. 1, in an embodiment.

The method 34 may first include a step 38 that includes determining user behavior data, which may include various types of item interactions, from a user behavior database (e.g., the user behavior database 14 of FIG. 2). User behavior data may be raw user behavior data from a database, or may be sorted, filtered, or otherwise pre-processed before use for determining anchor/accessory relationships. As nonlimiting examples, user behavior data may include co-purchase data (e.g., information relating to items purchased together in the same transaction/order, in-store and/or online), co-search data (e.g., items returned in the same search query results that are viewed by one or more a user(s) of a website), co-view data (groups of items that were viewed by a same user of a website within a predetermined amount of time or on a single visit to the website), or any other type of user behavior data that indicates how consumers interact with items. Step 72 of FIG. 3B further demonstrates graphically how example user behavior data may be used and modeled based on how users have interacted with groups of products in the past.

Some cleanup or pre-processing of data may also be performed. For example, filters may be applied to remove noise from the data. For example, orders with more items than a predetermined threshold (e.g., 98%) of other orders may be removed from the co-purchase data. Sessions with more product views than a predetermined threshold (e.g., 98%) of the sessions may be removed from the co-view data. Similarly, searches with more than a predetermined threshold (e.g., 9) different viewed product types may be ignored.

The method 34 may further include a step 40 that includes replacing items in the user behavior data determined at the step 38 with item type data. The step 40 corresponds with the graphical step 74 in FIG. 3B. In other words, the specific items that are purchased together, viewed during a same user browsing session together, etc. are replaced in the data set being analyzed with an item type or category in which each specific item is categorized. The specific items may be categorized into item types according to, for example, an item taxonomy. An item taxonomy may be a hierarchy of classification information about an item, which information may have been manually or automatically defined. For example, the taxonomy for a particular bathroom faucet having a single handle may be, from highest taxonomy level to lowest taxonomy level, “Bath->Bathroom Faucets->Bathroom Sink Faucets->Single Handle Bathroom Sink Faucets”. Some or all levels of the item taxonomy may be reflected in a hierarchical set of pages on a website of a retailer or other entity, in some embodiments. The various levels of the item taxonomy may be referred to herein as nodes. The lowest level of nodes, which have specific items classified therein, may be referred to herein as leaf nodes. In an item taxonomy, different specific items may be characterized into leaf nodes that have different numbers of higher level, or parent, nodes. In the nonlimiting example above, the “Single Handle Bathroom Sink Faucets” may be a lowest level, leaf node, and each of the “Bath,” “Bathroom Faucets,” and “Bathroom Sink Faucets” may be parent nodes of the leaf node. Accordingly, after user behavior data has been determined in the step 38 (e.g., two items that are co-purchased together), at step 40 those items are replaced in the data set with their leaf node item types. In this way, anchor/accessory relationships may be determined as described herein based on item types as classified in a taxonomy rather than between specific items themselves. Advantageously, this assists in determining accessory recommendations for newer or otherwise infrequently interacted with items that have little user behavior data associated therewith.

The method 34 may further include a step 42 that includes replacing a portion of item types in the user behavior data with parent item types from an item taxonomy. The step 42 is also represented graphically in step 76 of FIG. 3B. In other words, after the step 40, the user behavior data includes various data about how users have interacted with certain item types (because the specific items have been replaced with item types in the step 40). Those item types may represent lowest level leaf nodes from an item taxonomy. At the step 42, a portion of those leaf node item types are replaced with parent nodes of the leaf node. For example, with the faucets referenced with respect to the step 40, the “Single Handle Bathroom Sink Faucets” may be replaced in the user behavior data with a parent node such as “Bathroom Faucets” or “Bathroom Sink Faucets.” Anchor/accessory relationships may be determined exist across different lowest level item types (leaf nodes), and/or anchor accessory relationships may exist between a leaf node and a parent node or between two parent nodes. In this way, when applying a model to the user behavior data determine anchor/accessory relationships, anchor/accessory relationships between leaf nodes and/or parent nodes of an item taxonomy may be determined. The replacement of nodes with parent nodes may be at a random rate or at a predetermined rate (e.g., 10%). The replacement of nodes with parent nodes may also be controlled to only ever replace a node with a predetermined number of levels above the leaf node. For example, the replacements may only be with direct parents of the leaf, any of two parents above the leaf, etc. In another example, the replacement may be any parent except for a top level or some other predetermined number of top level nodes.

By using product types in a taxonomy (e.g., in the steps 40 and/or 42), the systems and methods herein can also determine accessory recommendations for items with which a user has not interacted with previously (e.g., for which there is no data at the step 38). This is possible because accessory recommendations may be determined for an item type, which covers specific items that may not yet have user interaction data (or specific items for which there is limited user interaction data). In addition, higher levels or nodes of a taxonomy may be substituted (e.g., at the steps 42 and/or 76) in various methods herein because item types at lower levels in a taxonomy may sometimes be too granular to broadly represent a product type that is useful for determining accessory recommendations. For example, a parent node related to televisions may be categorized into leaf nodes relating to organic light emitting diode (OLED) televisions, smart televisions, ultra-high definition (HD) televisions, etc. As a result, the best accessory for a television may not be apparent when assessing the leaf nodes related to specific televisions, but may be identified when assessing a parent node relating to televisions more broadly. Accordingly, a structure of an item taxonomy may provide useful information for determining accessories for product types or determining accessory product types from anywhere in an item taxonomy (not just between a same taxonomy level).

The method 34 may further include a step 44 that includes training a machine learning model using the user behavior data to be able to determine anchor/accessory relationships. The step 44 is also represented graphically in step 78 of FIG. 3B. Once the model is trained, additional anchor/accessory relationships may be determined using the model, and anchor/accessory relationships for new items that fit into an item type with already established anchor/accessory relationships may be determined. In an example, the machine learning model may be the Word2Vec algorithm. A trained model may be used to determine which item types (either leaf or parent nodes) indicate an essential anchor/accessory relationship. Specific anchor/accessory item recommendations may then be derived from the item type level essential anchor/accessory relationships determined according to the methods described herein.

FIG. 4A is a flow chart illustrating an embodiment of a method 46 for building anchor/accessory relationships according to various embodiments as described herein. A graphical representation of the method 46 is shown in method 80 of FIG. 4B. The method 46 may find use as the first step 22 in the method 10 of FIG. 1, in an embodiment.

The method 46 may first include a step 48 that includes determining user behavior data, which may be similar to the step 38 of FIG. 3A. The step 48 is also represented graphically in step 82 of FIG. 4B. The method 46 may further include a step 50 that includes constructing an item graph with item type data relating to items users have interacted with in the user behavior data. The step 50 is also represented graphically in step 84 of FIG. 4B. In particular, the item graph includes replacing the specific item information with item type information (e.g., leaf node data) and determining conditional probabilities of item types being interacted with by a user together. For example, a conditional probability of items of type X and type Y being purchased together may be determined from co-purchase data of users. Conditional probabilities of items of type X and type Y being viewed in the same user website session or being viewed after being returned in a particular search query may also be determined and used to construct the item graph. Similar to step 40 of FIG. 3A, in the item graph the specific items are replaced with item type information (e.g., from an item taxonomy).

The method 46 may further include a step 52 that includes generating random walks through the item graph based on the conditional probabilities in the item graph. The step 52 is also represented graphically in step 86 of FIG. 4B. For example, a DeepWalk algorithm may be used that starts at a random item type in the item graph illustrated by way of example in the step 84 of FIG. 4B, and moves to other item types based on the calculated conditional probabilities. Those walks yield ordered data that may be used to train a machine learning model (e.g., at step 56 discussed below) to determine anchor/accessory relationships, and that ordered data is also shown in the step 86 of FIG. 4B and is structured similarly to the data in the step 74 of FIG. 3B.

The item graph in the step 84 of FIG. 4B may be constructed from user behavior data. The nodes may represent item types, and edges are formed between every pair of item types that co-occur within the same context in the user behavior data. The co-occurrence context may depend on a dataset used. For co-purchase data, the context may be an order in which the items are purchased. For co-view data the context may be a one-hour period (or other time period) within a single user session. For co-search data, the context may a unique search query string. The edges of the item graph may then be weighted by a number of contexts in which each pair of items (or item types) co-occur. Specifically, an undirected graph may be constructed based on the co-occurrence of pairs of items (or item types) appearing within the same context, and may not require items to be accessed consecutively to be linked together. In the co-purchase data and the co-search data for example, there may be no logical ordering of items in each context, unlike in the co-view data where items may be clicked or selected sequentially. Therefore we may compute co-occurrences across an entire context for a dataset for certain types of user behavior data.

Once the item graph is constructed (e.g., as shown in the step 84 of FIG. 4B) the system may take random walks between nodes on the graph to generate node sequences, which are used to train a machine learning model such as a Word2Vec model. Each random walk may start at a vertex Vi, in the set of vertices V, and may take a predetermined number of steps (e.g., 9 steps) across neighboring nodes according to a transition probability, producing a predetermined path length of nodes (e.g., a path of 10 nodes) per walk. Each node may sampled uniformly, with a predetermined number of random walks (e.g., 500 random walks) generated per node, resulting in a large number of random walks overall. Equation 1 below describes the probability of transitioning from node νᵢ to node νⱼ, given an adjacency matrix A. N+(νᵢ) returns the set of immediate neighbors of the node Vi in the graph, and Aᵢⱼ represents the co-occurrence count of nodes νᵢ and νⱼ under some context based on the user behavior data.

$$P ( {v}_{j} \vert {v}_{i} ) = \{ \begin{matrix}\frac{{A}_{ij}}{{\sum }_{k ∈ {N}_{+} ( {v}_{i} )} {A}_{ik}} , & {v}_{j} ∈ {N}_{+} ( {v}_{i} ) \\ 0 , & {v}_{j} ∉ {N}_{+} ( {v}_{i} )\end{matrix} \qquad ( 1 )$$

The method 46 may further include a step 54 that includes replacing a portion of item types in the user behavior data with parent item types from an item taxonomy. The replacement may be, for example, similar to step 42 of FIG. 3A.

The method 46 may further include a step 56 that includes training a machine learning model using the user behavior data to be able to determine anchor/accessory relationships. Once the model is trained, additional anchor/accessory relationships may be determined using the model, and anchor/accessory relationships for new items that fit into an item type with already established anchor/accessory relationships may be determined. In an example, the machine learning model may be the Word2Vec algorithm. A trained model may be used to determine which item types (either leaf or parent nodes) indicate an essential anchor/accessory relationship. Specific anchor/accessory item recommendations may then be derived from the item type level essential anchor/accessory relationships determined according to the methods described herein.

In various embodiments, the systems and methods herein may also be used to determine negative examples of items or item types for accessory recommendations. For example, the methods and systems may identify items or item types that are rarely or never bought together, viewed together, found in the same search results, or otherwise interacted with by a user together. Such data may be useful in ruling out candidates for accessory recommendation consideration.

In various embodiments, item types may be replaced with a parent node item type as described herein. In order to generate what is referred to herein as hierarchical embeddings, before inputting lists of sequences of item types into a machine learning algorithm such as the Word2Vec algorithm, the item types may be preprocessed such that a predetermined percentage of product types in the sequences (e.g., 10% probability) of being replaced with one of its parent nodes from an item taxonomy. This is illustrated in the steps 76 and 88 of FIGS. 3B and 4B. All parent nodes may be configured to have an equal chance of replacing the leaf-node or lower level node. As each product type also represents an instance of one of its parents, the machine learning model may be trained in this way to learn to model transitions between taxonomy nodes of different hierarchy levels.

FIG. 5 is a diagrammatic view of an illustrative computing system that includes a general purpose computing system environment 120, such as a desktop computer, laptop, smartphone, tablet, or any other such device having the ability to execute instructions, such as those stored within a non-transient, computer-readable medium. Furthermore, while described and illustrated in the context of a single computing system 120, those skilled in the art will also appreciate that the various tasks described hereinafter may be practiced in a distributed environment having multiple computing systems 120 linked via a local or wide-area network in which the executable instructions may be associated with and/or executed by one or more of multiple computing systems 120.

In its most basic configuration, computing system environment 120 typically includes at least one processing unit 122 and at least one memory 124, which may be linked via a bus 126. Depending on the exact configuration and type of computing system environment, memory 124 may be volatile (such as RAM 130), non-volatile (such as ROM 128, flash memory, etc.) or some combination of the two. Computing system environment 120 may have additional features and/or functionality. For example, computing system environment 120 may also include additional storage (removable and/or non-removable) including, but not limited to, magnetic or optical disks, tape drives and/or flash drives. Such additional memory devices may be made accessible to the computing system environment 120 by means of, for example, a hard disk drive interface 132, a magnetic disk drive interface 134, and/or an optical disk drive interface 136. As will be understood, these devices, which would be linked to the system bus 126, respectively, allow for reading from and writing to a hard disk 138, reading from or writing to a removable magnetic disk 140, and/or for reading from or writing to a removable optical disk 142, such as a CD/DVD ROM or other optical media. The drive interfaces and their associated computer-readable media allow for the nonvolatile storage of computer readable instructions, data structures, program modules and other data for the computing system environment 120. Those skilled in the art will further appreciate that other types of computer readable media that can store data may be used for this same purpose. Examples of such media devices include, but are not limited to, magnetic cassettes, flash memory cards, digital videodisks, Bernoulli cartridges, random access memories, nano-drives, memory sticks, other read/write and/or read-only memories and/or any other method or technology for storage of information such as computer readable instructions, data structures, program modules or other data. Any such computer storage media may be part of computing system environment 120.

A number of program modules may be stored in one or more of the memory/media devices. For example, a basic input/output system (BIOS) 144, containing the basic routines that help to transfer information between elements within the computing system environment 120, such as during start-up, may be stored in ROM 128. Similarly, RAM 130, hard drive 138, and/or peripheral memory devices may be used to store computer executable instructions comprising an operating system 146, one or more applications programs 148 (such as a Web browser, retailer's mobile app, retailer's point-of-sale checkout and ordering program, and/or other applications that execute the methods and processes of this disclosure), other program modules 150, and/or program data 152. Still further, computer-executable instructions may be downloaded to the computing environment 120 as needed, for example, via a network connection.

An end-user, e.g., a customer, retail associate, and the like, may enter commands and information into the computing system environment 120 through input devices such as a keyboard 154 and/or a pointing device 156. While not illustrated, other input devices may include a microphone, a joystick, a game pad, a scanner, etc. These and other input devices would typically be connected to the processing unit 122 by means of a peripheral interface 158 which, in turn, would be coupled to bus 126. Input devices may be directly or indirectly connected to processor 122 via interfaces such as, for example, a parallel port, game port, firewire, or a universal serial bus (USB). To view information from the computing system environment 120, a monitor 160 or other type of display device may also be connected to bus 26 via an interface, such as via video adapter 162. In addition to the monitor 160, the computing system environment 120 may also include other peripheral output devices, not shown, such as speakers and printers.

The computing system environment 120 may also utilize logical connections to one or more computing system environments. Communications between the computing system environment 120 and the remote computing system environment may be exchanged via a further processing device, such a network router 172, that is responsible for network routing. Communications with the network router 172 may be performed via a network interface component 174. Thus, within such a networked environment, e.g., the Internet, World Wide Web, LAN, or other like type of wired or wireless network, it will be appreciated that program modules depicted relative to the computing system environment 120, or portions thereof, may be stored in the memory storage device(s) of the computing system environment 120.

The computing system environment 120 may also include localization hardware 176 for determining a location of the computing system environment 120. In embodiments, the localization hardware 176 may include, for example only, a GPS antenna, an RFID chip or reader, a WiFi antenna, or other computing hardware that may be used to capture or transmit signals that may be used to determine the location of the computing system environment 120.

While this disclosure has described certain embodiments, it will be understood that the claims are not intended to be limited to these embodiments except as explicitly recited in the claims. On the contrary, the instant disclosure is intended to cover alternatives, modifications and equivalents, which may be included within the spirit and scope of the disclosure. Furthermore, in the detailed description of the present disclosure, numerous specific details are set forth in order to provide a thorough understanding of the disclosed embodiments. However, it will be obvious to one of ordinary skill in the art that systems and methods consistent with this disclosure may be practiced without these specific details. In other instances, well known methods, procedures, components, and circuits have not been described in detail as not to unnecessarily obscure various aspects of the present disclosure.

Some portions of the detailed descriptions of this disclosure have been presented in terms of procedures, logic blocks, processing, and other symbolic representations of operations on data bits within a computer or digital system memory. These descriptions and representations are the means used by those skilled in the data processing arts to most effectively convey the substance of their work to others skilled in the art. A procedure, logic block, process, etc., is herein, and generally, conceived to be a self-consistent sequence of steps or instructions leading to a desired result. The steps are those requiring physical manipulations of physical quantities. Usually, though not necessarily, these physical manipulations take the form of electrical or magnetic data capable of being stored, transferred, combined, compared, and otherwise manipulated in a computer system or similar electronic computing device. For reasons of convenience, and with reference to common usage, such data is referred to as bits, values, elements, symbols, characters, terms, numbers, or the like, with reference to various embodiments of the present invention.

It should be borne in mind, however, that these terms are to be interpreted as referencing physical manipulations and quantities and are merely convenient labels that should be interpreted further in view of terms commonly used in the art. Unless specifically stated otherwise, as apparent from the discussion herein, it is understood that throughout discussions of the present embodiment, discussions utilizing terms such as “determining” or “outputting” or “transmitting” or “recording” or “locating” or “storing” or “displaying” or “receiving” or “recognizing” or “utilizing” or “generating” or “providing” or “accessing” or “checking” or “notifying” or “delivering” or the like, refer to the action and processes of a computer system, or similar electronic computing device, that manipulates and transforms data. The data is represented as physical (electronic) quantities within the computer system's registers and memories and is transformed into other data similarly represented as physical quantities within the computer system memories or registers, or other such information storage, transmission, or display devices as described herein or otherwise understood to one of ordinary skill in the art.

What is claimed is:

1. A computer-implemented method, comprising:
determining, by a processor of a computing device, user behavior data comprising a plurality of ordered user interactions with a plurality of items via an electronic interface;
replacing, by the processor, each of the plurality of items in the user behavior data with a respective item type;
constructing, by the processor, an item graph using the user behavior data, wherein the item graph comprises a plurality of interconnected nodes indicative of a plurality of item types, and wherein the plurality of interconnected nodes are further configured to a probability for how likely two item types are to appear together in the plurality of ordered user interactions;
performing, by the processor, a plurality of random walks through the item graph to generate a plurality of node sequences, wherein the plurality of random walks are performed based on the probability for how likely two item types are to appear together in the plurality of ordered user interactions;
replacing, by the processor, a predetermined number of nodes represented in the plurality of node sequences with a respective parent item type of a plurality of parent item types from an item taxonomy; and
inputting, by the processor, the plurality of node sequences into a machine learning algorithm to train the machine learning algorithm to determine an anchor/accessory relationship between at least one of the plurality of item types and at least one of the plurality of parent item types.

2. The computer-implemented method of claim 1, wherein the user behavior data comprises co-view data indicative of viewed items displayed to a user on the electronic interface during a single user viewing session.

3. The computer-implemented method of claim 1, wherein the user behavior data comprises co-search data indicative of items displayed to a user on the electronic interface during a single search query.

4. The computer-implemented method of claim 1, wherein the user behavior data comprises co-purchase data indicative of items purchased at the same time by a user via the electronic interface during a single search query.

5. The computer-implemented method of claim 1, wherein the item taxonomy comprises having a plurality of lowest level leaf nodes, a first level of parent nodes organized in a hierarchy above the plurality of lowest level leaf nodes, and a second level of parent nodes organized in the hierarchy above the first level of parent nodes.

6. The computer-implemented method of claim 5, wherein the plurality of lowest level leaf nodes each represents the respective item type in which the plurality of items is categorized.

7. The computer-implemented method of claim 6, wherein each of the first level of parent nodes represents one of the plurality of parent item types in which one or more of the respective item types is categorized.

8. A non-transitory computer-readable medium having computer executable instructions stored thereon that, upon execution by a processing device, cause the processing device to perform operations comprising:
determining, by a processor of a computing device, user behavior data comprising a plurality of ordered user interactions with a plurality of items via an electronic interface;
replacing, by the processor, each of the plurality of items in the user behavior data with a respective item type of a plurality of item types;
replacing, by the processor, a predetermined number of the respective item types in the plurality of ordered user interactions with a respective parent item type of a plurality of parent item types from an item taxonomy; and
inputting, by the processor, the plurality of ordered user interactions into a machine learning algorithm to train the machine learning algorithm to determine an anchor/accessory relationship between at least one of the plurality of item types and at least one of the plurality of parent item types.

9. The non-transitory computer readable medium of claim 8, wherein the user behavior data comprises co-view data indicative of viewed items displayed to a user on the electronic interface during a single user viewing session.

10. The non-transitory computer readable medium of claim 8, wherein the user behavior data comprises co-search data indicative of items displayed to a user on the electronic interface during a single search query.

11. The non-transitory computer readable medium of claim 8, wherein the user behavior data comprises co-purchase data indicative of items purchased at the same time by a user via the electronic interface during a single search query.

12. The non-transitory computer readable medium of claim 8, wherein the item taxonomy comprises having a plurality of lowest level leaf nodes, a first level of parent nodes organized in a hierarchy above the plurality of lowest level leaf nodes, and a second level of parent nodes organized in the hierarchy above the first level of parent nodes.

13. The non-transitory computer readable medium of claim 12, wherein the plurality of lowest level leaf nodes each represents the respective item type in which the plurality of items is categorized.

14. The non-transitory computer readable medium of claim 13, wherein each of the first level of parent nodes represents one of the plurality of parent item types in which one or more of the respective item types is categorized.

15. The non-transitory computer readable medium of claim 8, wherein the instructions further cause the processing device to perform operations comprising receiving, by the processor after the machine learning algorithm is trained to yield a trained algorithm, data indicative of a user selection of a first item.

16. The non-transitory computer readable medium of claim 15, wherein the instructions further cause the processing device to perform operations comprising determining, by the processor using the trained algorithm, at least one accessory recommendation for the first item.

17. The non-transitory computer readable medium of claim 16, wherein at least one accessory recommendation comprises two or more accessory recommendations.

18. The non-transitory computer readable medium of claim 8, wherein the instructions further cause the processing device to perform operations comprising:
determining, by the processor after the machine learning algorithm is trained to yield a trained algorithm, a plurality of anchor/accessory relationships using the trained algorithm; and
storing, by the processor, the plurality of anchor/accessory relationships in a lookup table stored in a memory.

19. The non-transitory computer readable medium of claim 8, wherein the instructions further cause the processing device to perform operations comprising receiving, by the processor, data indicative of a user selection of a first item.

20. The non-transitory computer readable medium of claim 8, wherein the instructions further cause the processing device to perform operations comprising:
determining, by the processor, at least one accessory recommendation for the first item using the lookup table; and
sending, by the processor, the at least one accessory recommendation to an electronic device operated by a user who made the user selection.
